(19) United States
(12) Patent Application Publication
(10) Pub. No.: US 2007/0127266 A1
(43) Pub. Date: Jun. 7, 2007

(54) LIGHT GUIDE MEMBER, SURFACE LIGHT EMITTING DEVICE, AND LIGHT EMITTING SENSOR DEVICE

(75) Inventor: Takuro Sugiura, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/549,501

(22) Filed: Oct. 13, 2006

(30) Foreign Application Priority Data
Oct. 18, 2005 (JP) 2005-303261

(51) Int. Cl. F21V 7/04

(52) U.S. Cl. 362/615

(57) ABSTRACT

A light guide member, a surface light emitting, and a light emitting sensor device are provided. The light guide member comprises an end face that receives light from a light source. A pair of main surfaces are opposed to each other. An optical path changing device is disposed on one of the main surfaces. A projection portion extends by a predetermined length from the light guide portion toward the outside of the light guide member.

This patent document claims the benefit of Japanese Patent Application Number 2005-303261 filed on Oct. 18, 2005, which is hereby incorporated by reference.

### BACKGROUND

1. Field

The present embodiments relate to a light guide member, a surface light emitting, and a light emitting sensor device.

2. Related Art

The light guide member has hitherto been widely used, for example, the light guide member has been employed for a front light device or back light device known as a lighting means for a liquid crystal display device. Such a front light device typically comprises a light source, light guide plate (light guide member) that emits light from the light source to a liquid crystal display panel, and prisms for efficiently supplying light from the light guide plate to the liquid crystal display panel. This light guide plate has a planar shape and includes a pair of main surfaces opposed to each other, and a pair of end faces opposed to each other. The liquid crystal display panel is arranged on one main surface while the light source is arranged in the vicinity of one end face. In order to reflect light from the light source, a reflection plate is arranged on the other main surface.

FIG. 6 shows a light guide plate 100 having continuous prisms each of which has a scalene triangular cross-section, formed using a so-called prism technique for front light. Such a light guide plate 100 is disclosed in, for example, Japanese Unexamined Patent Application Publication No. 2005-165199. The light guide plate 100 disclosed has a pair of end faces 100a, 100b capable of receiving light L from a light source 110 (for example, in FIG. 6, a first end face 100a receives the light L). A pair of first and second main surfaces 100c and 100d orthogonally intersect the end faces 100a and 100b, and that are opposed to each other. On the first main surface 100c of the light guide plate 100, there are provided continuous prisms 105, each comprising a sawtooth-shaped portion. The prisms 5 control the traveling direction of the light L from the light source light source light source 110, guided through the light guide plate 100.

As shown in FIG. 7, in an enlarged form, the prisms 105 comprise the sawtooth-shaped portions each of which has a substantially scalene triangular cross-section. The prisms 5 being formed by alternately arranging gentle slope portions 105a tilting at an angle with respect to the first main surface 100c and steep slope portions 105b tilting at a steep angle with respect to the first main surface 100c. The prisms 105 direct the light L from the light source light source 110, guided through the light guide plate 100 only toward the second main surface 100d.

Light-receiving portions 108a of the gentle slope portions 105a obliquely extend in the longitudinal direction of the light guide plate so as to depart from the light source 110, and efficiently propagates the light L from the light source 110 to the inside of the light guide plate 100 while reflecting the light L.

Alternatively, light-receiving surfaces 108b of the steep slopes 105b are directed toward the first end face 100a side where the light source 110 is located, and efficiently change a path of the light L from the light source light source 110, incident from the first end face 100a toward the second end face 1d.

The light guide plate 100 as disclosed in the Japanese Unexamined Patent Application Publication No. 2005-165199 can variously used. For example, as shown in FIG. 6, the light guide plate is used in combination with a sensor (such as an electrostatic sensor or pressure-sensitive sensor) 130 in a planar input device, such as a touch panel, or pointing device (e.g., glide point), that operates upon detecting an extraneous stress of an electrical change of a surface. However, the following problem occurs with this combination.

When attempting to realize an illuminating function of emitting light in a predetermined form, accompanied with an operation of the sensor 130 by arranging a light emitting device having the light guide plate 100, above the sensor 130 that operates upon detecting an extraneous stress of an electrical change of a surface, it is necessary to strongly adhere the light guide plate 100 to the sensor 130 in order to correctly convey a stress applied through the light guide plate 100 or an electrical change of a surface to the sensor 130, and simultaneously, to prevent the light guide plate 100 itself from being moved by the extraneous stress. For this purpose, in the example shown in FIG. 6, a reflection plate 125, which constitutes the light emitting device together with the light guide plate 100, its entire surface adhered to the light guide plate 100 by a first adhesion sheet 120, and to the sensor 130 by a second adhesion sheet 122.

As shown in FIG. 8, in an enlarged form, such strong adhesive fixation of the entire surface of the light guide plate 100, performed by using the adhesion sheets 120 and 122 undesirably buries the prism portions 105 of minute shape, arranged on the first main surface 100a of the light guide plate 100, under the first adhesion sheets 120. The prism portions 105 lose their light reflection function based on the difference in refraction indices. The light reflection function being an intrinsic role of the prism portions 105.

Since the light L leaks from the adhered portion, the light guiding efficiency of the light emitting device remarkably decreases, resulting in a significant reduction in the luminance uniformity of the light emitting surface.

A light guide member and surface light emitting device capable of being strongly fixed to a sensor without impairing its optical characteristic is desired.

### SUMMARY

In one embodiment, a light guide member includes an end face receiving light from a light source, and a pair of main surfaces opposed to each other. The light guide member includes optical path changing means that is arranged on one of the main surfaces, and that has light guide portions for propagating the light from the light source to the inside of the light guide member. Reflective light emitting portions for causing the light from the light source to reflect toward the other of the main surfaces. The projecting portions are mounted on the light guide portion in a projecting manner, and extend by a predetermined length from the light guide portion toward the outside of the light guide member.

In this embodiment, for example, the light guide member is to be fixed to a predetermined mounting surface or adhesive layer. The projecting portions are each interposed between the mounting surface or the adhesive layer and the light guide portion to thereby prevent contact between the optical path changing means and the mounting surface or the adhesive layer. For example, it is possible to avoid the optical path changing means from being buried under the adhesive layer, as well as to prevent the optical path changing means from being deformed or deteriorated even when a stress, such as a pressure, acts on the light guide member.

Appropriate spaces s are secured between the mounting surface or the adhesive layer and the light guide member (also between the light reflector and the light guide member if a light reflector is provided oppositely to the light guide member) by virtue of the projecting portions. Accordingly, it is possible, for example, to efficiently guide light that propagates through the light guide member.

The projecting portions are provided not on the reflective light emitting portions but on the light guide portions. There is no possibility that the projecting portions 30 hinder the reflective light emitting portions from emitting light. For example, the light guide member with above-described arrangement can be strongly fixed to the mounting surface or the adhesive layer without impairing its optical characteristic. Even when the adhesive fixation of the light guide member is not involved, the projecting portions are effective as countermeasures against the Newton's rings or the sticking of a film member such as the reflection plate, due to static electricity.

In one embodiment, a light guide member includes an end face that receives light from a light source and a pair of main surfaces opposed to each other, and that is fixed on a predetermined mounting surface. This light guide member includes optical path changing means that is arranged on one of the main surfaces, and that has light guide portions for propagating the light from the light source to the inside of the light guide member. Reflective light emitting portions cause the light from the light source to reflect toward the other of the main surfaces. Projecting portions each of which is mounted on the light guide portion in a projecting manner, and each of which is interposed between the mounting surface and the light guide portion, in order to prevent the optical path changing means from making contact with the mounting surface when the optical path changing means is to be fixed on the mounting surface.

In this embodiments the light guide member is fixed to the predetermined mounting surface. The projecting portions are each interposed between the mounting surface and the light guide portion to thereby prevent contact between the optical path changing means and the mounting surface. It is possible to avoid the optical path changing means from being buried under the mounting surface, as well as to prevent the optical path changing means from being deformed or deteriorated even when a stress, such as a pressure, acts on the light guide member.

In one embodiment, appropriate spaces s are secured between the mounting surface and the light guide member (also between the light reflector and the light guide member if a light reflector is provided oppositely to the light guide member) by virtue of the projecting portions. It is possible to efficiently guide light that propagates through the light guide member.

In one embodiment, the projecting portions are provided not on the reflective light emitting portions but on the light guide portions, there is no possibility that the projecting portions 30 hinder the reflective light emitting portions from emitting light. For example, the light guide member with above-described arrangement is strongly fixed to the mounting surface without impairing its optical characteristic.

According to another embodiment, a light guide member includes an end face that receives light from a light source and a pair of main surfaces opposed to each other, and that is adhesively fixed on a predetermined adhesive layer. This light guide member includes optical path changing means that is arranged on one of the main surfaces. Light guide portions propogate the light from the light source to the inside of the light guide member. Reflective light emitting portions that cause the light from the light source to reflect toward the other of the main surfaces. Projecting portions each of which is mounted on the light guide portion in a projecting manner, and each of which is interposed between the adhesive layer and the light guide portion, in order to prevent the optical path changing means from making contact with the adhesive layer when the optical path changing means is to be fixed on the adhesive layer.

According to this embodiment, the light guide member is fixed to the adhesive layer. The projecting portions are interposed between the adhesive layer and the light guide portion to thereby prevent contact between the optical path changing means and the adhesive layer. It is possible to avoid the optical path changing means from being buried under the adhesive layer, as well as to prevent the optical path changing means from being deformed or deteriorated even when a stress, such as a pressure, acts on the light guide member.

In one embodiment, appropriate spaces s are secured between the adhesive layer and the light guide member (also between the light reflector and the light guide member if a light reflector is provided oppositely to the light guide member) by virtue of the projecting portions. It is possible to efficiently guide light that propagates through the light guide member.

In one embodiment, the projecting portions are provided not on the reflective light emitting portions but on the light guide portions. Accordingly, there is no possibility that the projecting portions 30 hinder the reflective light emitting portions from emitting light. For example, the light guide member with above-described arrangement can be strongly fixed to the adhesive layer without impairing its optical characteristic.

In one embodiment, it is preferable that the optical path changing means comprise continuous sawtooth-shaped prisms each of which has a substantially scalene triangular cross-section. The prisms being formed by alternately arranging the light guide portions tilting at a predetermined first angle with respect to the one of the main surfaces, and the reflective light emitting portions tilting at a second angle larger than the first angle with respect to the one of the main surfaces.

In this embodiment, it is possible to efficiently guide light from the light source to the inside of the light guide member by the light guide portions, as well as to cause the guided light to efficiently reflect by the reflective light emitting portions. Simultaneously, it is possible to cause light in a substantially normal direction to pass through by the light guide portions. This allows a light emission display by the prism portions in a complicated and fine form to be easily and accurately performed.

In one embodiment, the front end of each of the projecting portions preferably has a substantially hemispheric shape. This arrangement allows stable adhesion.

In one embodiment, the projection portions are preferably aligned with each other at substantially uniform spacings. In this embodiment, it is possible to satisfactorily ensure the uniformity of luminance of light emitted from the light guide member.

In one embodiment, it is preferable that, by providing the optical path changing means in only a predetermined region on the one of the main surfaces of the light guide member, only the predetermined region be made luminous (for example, it is preferable to make characters or symbols luminous by attaching prism shapes in part to the light guide member).

In another embodiment, it is preferable to form projecting portions even in regions in which no optical path changing means is provided, on the one of the main surfaces of the light guide member. In this embodiment, a strong adhesive force can be achieved by all of the projecting portions with no prism shape attached, for example, all of the non-light-emitting portions, in the light guide member.

In one embodiment, the light guide member includes a material having a refractive index higher than that of a material used for the adhesive layer.

There are also provided a surface light emitting device and light emitting sensor device having the light guide member with the above-described arrangement. For example, the surface light emitting device includes a light source, a light guide member with the above-described arrangement, a light reflector or light absorber that is opposed to the one main surface, on which the light path changing means is arranged. The light emitting sensor device has a sensor that operates upon detecting an extraneous stress or an electrical change of a surface, and the surface light emitting device fixed on the above-described sensor.

The light guide member and surface light emitting device can be strongly fixed to a predetermined object such as a sensor without impairing their optical characteristics. According to the light emitting sensor device having such a light guide member or surface light emitting device, the light guide member or surface light emitting device can be strongly fixed to the sensor without impairing their optical characteristics.

### BRIEF DESCRIPTION OF THE DRAWINGS

FIG. 1 is a schematic construction diagram of a surface light emitting device according to a first embodiment FIG. 2 is a schematic construction diagram of a surface light emitting device according to a second embodiment;

FIG. 3 is a schematic construction diagram of a surface light emitting device according to a third;

FIGS. 4A to 4C show an example of specific constructions of the surface light emitting device in FIG. 1;

FIG. 5 is a construction diagram of a light emitting sensor device having the surface light emitting device in FIG. 1;

FIG. 6 is a schematic construction diagram of a planar input device formed by combining a sensor that operates upon detecting an extraneous stress, and a surface light emitting device having a conventional light guide plate;

FIG. 7 is a diagram explaining operations of a light guide plate having scalene triangular prisms, using a prism technique of front light; and

FIG. 8 is a schematic construction diagram of a surface light emitting device having a conventional light guide plate.

### DETAILED DESCRIPTION

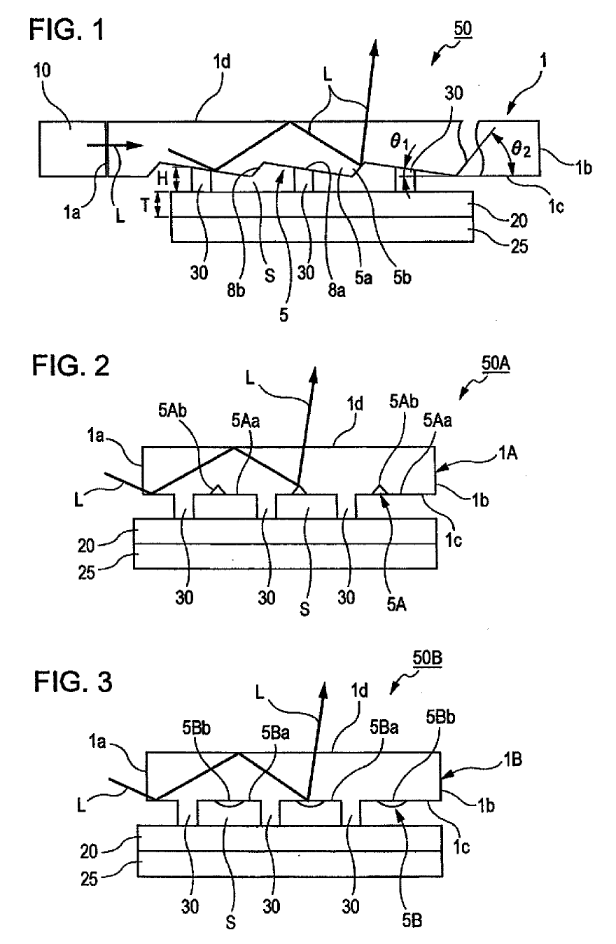

In one embodiment, as shown in FIG. 1, a surface light emitting device 50 includes a light guide plate 1, serving as a light guide member. As shown in FIG. 1, the surface light emitting device 50 includes a light guide plate 1, light source 10, and reflection plate 25, serving as a light reflector securely adhered to the light guide plate 1 via an adhesion sheet 20 serving as an adhesive layer.

The light guide plate 1 is constituted of a transparent member (optically transparent material), and includes a pair of end faces 1a and 1b, capable of receiving light L from the light source 10 (in FIG. 1, a first end face 1a receives the light L). A pair of first and second main surfaces 1c and 1d orthogonally intersect the end faces 1a and 1b and that are opposed to each other.

On the first main surface 1c of the light guide plate 1, there are provided prisms 5 that serve as optical path changing means, comprising continuous sawtooth-shaped portions having a predetermined configuration. The prisms 5 control the traveling direction of the light L from the light source 10, guided through the light guide plate 1 to direct the light L toward the second main surface 1d. For example, the prisms 5 include continuous sawtooth-shaped portions each of which has a substantially scalene triangular cross-section. The prisms 5 being formed by alternately arranging gentle slope portions 5a, each serving as a light guide portion tilting at a predetermined first angle θ1 with respect to the first main surface 1c, and steep slope portions 5b, each serving as a reflective light emitting portion tilting at a second angle θ2 larger than the first angle θ1 with respect to the first main surface 1c. The prisms 5 direct the light L from the light source 10, guided through the light guide plate 1 only toward the second main surface 1d.

A light-receiving portion 8a of each of the gentle slope portions 5a obliquely extends in the longitudinal direction of the light guide plate so as to depart from the light source 10, and efficiently propagates the light L from the light source 10 to the inside of the light guide plate 1 while reflecting the light L.

Alternatively, a light-receiving surface 8b of each of the steep slopes 5b is directed toward the first end face 1a side where the light source 10 is located, and efficiently reflects the light L from the light source light source 10, incident from the first end face 1a, toward the second end face 1d. The tilt angle θ1 of each of the gentle slope portions 5a is set to an angle (e.g., 2.5 degrees) allowing light in a substantially normal direction (direction substantially perpendicular to the main surfaces 1c and 1d) to pass through. Such a light guide plate 1 having the prisms 5 can be formed by, for example, an injection molding method.

On each gentle slope portion 5a, which serves as a light guide portion constituting the prism 5 of the light guide plate 1, a projecting portion 30 extends at a predetermined length (height) toward the outside of the light guide plate 1 is mounted in a projecting manner. These projecting portions 30 are interposed between an adhesion sheet 20 and the light guide plate 1 in order to prevent the prisms 5 from making contact with the adhesion sheet 20 when the light guide plate 1 is to be securely adhered to a reflection plate 25 (which is opposed to the first main surface 1c of the light guide plate 1) via the adhesion sheet 20, for example, when the light guide plate 1 (projecting portions 30) is fixed to the adhesion surface (mounting surface) of the adhesion sheet 20. The projecting portions 30 form predetermined spaces (gaps) s between the adhesion sheet 20 and the light guide plate 1.

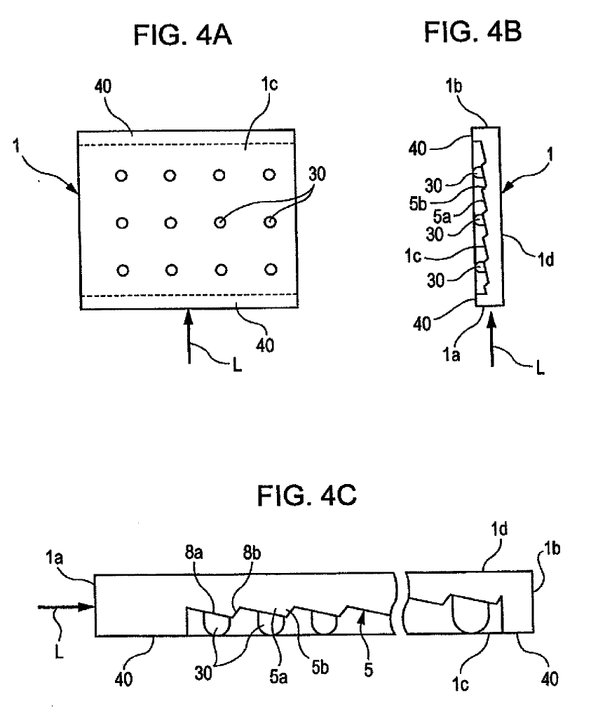

In order to enhance the adhesion force of the light guide plate 1 with respect to the light reflector 25 (adhesion sheet 20), it is preferable that, in the light guide plate 1, flat adhesion surfaces 40 is provided on both sides of first main surface 1c, as shown in FIG. 4.

In one embodiment, it is preferable that the height (length) H of the projecting portion 30 be higher (longer) than the thickness of the adhesion sheet 20. This prevents contact between the prisms 5 and adhesion sheet 20. For example, when the thickness of the adhesion sheet 20 is about 30 μm, the height of the projecting portion 30 is preferably about 75 to 200 μm.

The number of the projecting portions 30, for example, when the diameter of the projecting portion 30 is about 0. 2 mm and the size of the first main surface 1c is about 52.6 mm×66.0 mm (for example, when the adhesion surfaces 40 with a predetermined width, e.g., about 2.0 mm to 5.0 mm, are provided on both sides of the first main surface 1c of the light guide plate 1, as shown in FIG. 4), the number of the projecting portions 30 is preferably about 2000 to 3000.

In one embodiment, the projecting portion 30 may have a cylindrical shape. However, as shown in FIG. 4, the front end of the projecting portion 30 preferably has a substantially hemispherical shape. Forming the front end of each of the projecting portions 30 into a substantially hemispherical shape provides stable adhesion.

In one embodiment, the projecting portions 30 are preferably formed of the same material as that of the light guide plate 1, and they are substantially uniformly arranged at a fixed density within the first main surface 1c of the light guide plate 1. As shown in FIG. 4, for example, the projecting portions 30 are preferably aligned with one another at uniform spacings from side to side and up and down. According to this embodiment, the luminance of light emitted from the light guide plate 1 is satisfactorily ensured.

According to this embodiment, the light guide plate 1 is fixed to the adhesion sheet 20. The projecting portions 30 are each interposed between the adhesion sheet 20 and gentle slope portion 5a to thereby prevent contact between the prisms 5 and adhesion sheet 20. It is possible to avoid the prisms 5 from being buried under the adhesion sheet 20, as well as to prevent the prisms 5 from being deformed or deteriorated even when a stress, for example, a pressure, acts on the light guide plate 1.

In one embodiment, appropriate spaces s are secured between the adhesion sheet 20 (reflection plate 25) and light guide plate 1 by virtue of the projecting portions 30. It is possible to efficiently guide light that propagates through the light guide plate 1.

In one embodiment, the projecting portion 30 are provided not on the steep slopes 5b, each serving as a reflective light emitting portion, but on the gentle slope portions 5a, each serving as a light guide portion, there is no possibility that the projecting portions 30 hinder the steep slopes 5b from emitting light. For example, the light guide plate 1 according to this embodiment can be strongly fixed to the adhesion sheet 20 without impairing its optical characteristic.

FIG. 2 shows a surface light emitting device 50A having a light guide plate 1A serving as a light guide member according to a second embodiment. In this embodiment, components common to those in the first embodiment are designated by the same reference numerals, and the description thereof is omitted to avoid redundancy.

As shown in FIG. 2, on a first main surface 1c of a light guide plate 1A in this embodiment, an optical path changing means 5A comprises continuous sawtooth-shaped portions having a predetermined configuration. The optical path changing means 5A controls the traveling direction of light L from a light source (not shown), guided through the light guide plate 1A to direct the light L toward a second main surface 1d. For example, the optical path changing means 5A is formed by alternately arranging flat surface portions 5Aa, each serving as a light guide portion defining a first main surface 1c, and minute shape portions 5Ab, each serving as a reflective light emitting portion tilting at a predetermined angle with respect to the first main surface 1c. The optical path changing means 5A directs the light L from the light source light source, guided through the light guide plate 1A only toward the second main surface 1d. The flat surface portion 5Aa efficiently propagates the light L from the light source to the inside of the light guide plate 1A while reflecting the light L. Alternatively, the minute shape portions 5Ab efficiently reflects the light L from the light source light source, incident from the first end face 1a toward the second end face 1d.

On each flat surface portion 5Aa, which serves as a light guide portion constituting the optical path changing means 5A of the light guide plate 1A, a projecting portion 30 that extends at a predetermined length (height) toward the outside of the light guide plate 1A is mounted in a projecting manner. These projecting portions 30 are interposed between an adhesion sheet 20 and the light guide plate 1A in order to prevent the optical path changing means 5A from making contact with the adhesion sheet 20 when the light guide plate 1A is securely adhered to a reflection plate 25 via the adhesion sheet 20, for example, when the light guide plate 1A (projecting portions 30) is to be fixed to the adhesion surface (mounting surface) of the adhesion sheet 20. The projecting portions 30 form predetermined spaces (gaps) s between the adhesion sheet 20 and the light guide plate 1A.

According to this embodiment, as in the case of the above-described first embodiment, when the light guide plate 1A is to be fixed to the adhesion sheet 20, the projecting portions 30 are each interposed between the adhesion sheet 20 and flat surface portion 5Aa to thereby prevent contact between the optical path changing means 5A and adhesion sheet 20. It is possible to avoid the optical path changing means 5A from being buried under the adhesion sheet 20, as well as to prevent the optical path changing means 5A from being deformed or deteriorated even when a stress, for example, a pressure, acts on the light guide plate 1A.

In one embodiment, appropriate spaces s are secured between the adhesion sheet 20 (reflection plate 25) and light guide plate 1A by the projecting portions 30. It is possible to efficiently guide light propagating through the light guide plate 1A.

In one embodiment, the projecting portions 30 are provided not on minute shape portions 5Ab, each serving as a reflective light emitting portion, but on the flat surface portions 5Aa, each serving as a light guide portion. Accordingly, there is no possibility that the projecting portions 30 hinder the minute shape portions 5Ab from emitting light. If the reflective light emitting portions and projecting portions make contact with each other, a light emission defective portions are formed, for example, black spots or grid-shaped dark lines, thereby reducing the uniformity of luminance within the light emitting surface.

Projecting portions are fixed to the reflection plate via the adhesion seat. However, the projecting portions are not necessarily required to be fixed to the reflection plate, but may be fixed to a light absorber. In this embodiment, although the emission luminance decreases, the ratio between the luminance during emission and that during non-emission is large, so that the discrimination between lighting and non-lighting can be easily made by a visual recognition.

By attaching the optical path changing means only at a predetermined location on the main surface of the light guide plate, it is possible to cause only the predetermined region of a light emission shape to emit light. In this embodiment, arranging the light guide plate on the above-described light absorber makes large the ratio between the luminance during emission and that during non-emission. This allows the region of the light emission shape to be visually identified in a distinct manner.

In one embodiment, the light guide plate in which the optical path changing means is attached in part as described above, by causing all regions that are not allowed to emit light to become projecting portions, it is possible to achieve a stronger adhesion force.

However, there is a possibility that the luminance at a region remote from the light source decreases due to the increase in adhesion area and the decrease in light propagation capability within the light guide plate. In one embodiment, the light guide plate includes a material having a refraction index higher than that of the adhesion sheet. This may prevent the above-described decrease in luminance.

FIG. 3 shows a surface light emitting device 50B having a light guide plate 1B serving as a light guide member according to a third embodiment. In this embodiment, components common to those in the first embodiment are designated by the same reference numerals, and the description thereof is omitted to avoid redundancy.

As shown in FIG. 2, on a first main surface 1c of a light guide plate 1B in this embodiment, there is provided optical path changing means 5B having a predetermined configuration. The optical path changing means 5B controls the traveling direction of light L from a light source (not shown), guided through the light guide plate 1B to direct the light L toward a second main surface 1d. For example, the optical path changing means 5B is constructed by forming light-emitting print portions 5Bb including, for example, paint, at uniform spacings on the first main surface 1c. The light-emitting print portions 5Bb efficiently reflect the light L from the light source incident from the first end face 1a toward the second main surface 1d, for example, as a reflective light emitting portion 5Ab. Alternatively, the region on the first main surface 1c, in which no light-emitting print portion is formed, for example, non-light-emitting print portion 5Ba, efficiently propagates the light L from the light source 10 to the inside of the light guide plate 1B while reflecting the light L.

On each non-light-emitting print portion 5Bb, which serves as a light guide portion constituting the optical path changing means 5B of the light guide plate 1B, a projecting portion 30 that extends at a predetermined length (height) toward the outside of the light guide plate 1B is mounted in a projecting manner. These projecting portions 30 are interposed between an adhesion sheet 20 and the light guide plate 1B in order to prevent the optical path changing means 5B from making contact with the adhesion sheet 20 when the light guide plate 1B is securely adhered to a reflection plate 25 via the adhesion sheet 20. For example, the light guide plate 1B (projecting portions 30) is fixed to the adhesion surface (mounting surface) of the adhesion sheet 20. The projecting portions 30 form predetermined spaces (gaps) s between the adhesion sheet 20 and the light guide plate 1B.

According toone embodiment, as in the case of the above-described first embodiment, the light guide plate 1B is fixed to the adhesion sheet 20. The projecting portions 30 are each interposed between the adhesion sheet 20 and non-light-emitting print portion 5Ba to thereby prevent contact between the optical path changing means 5B and adhesion sheet 20. It is possible to avoid the optical path changing means 5B from being buried under the adhesion sheet 20, as well as to prevent the optical path changing means 5B from being deformed or deteriorated even when a stress, for example, a pressure, acts on the light guide plate 1B.

In one embodiment, appropriate spaces s are secured between the adhesion sheet 20 (reflection plate 25) and light guide plate 1B by virtue of the projecting portions 30. It is possible to efficiently guide light propagating through the light guide plate 1B.

In one embodiment, the projecting portions 30 are provided not on the light-emitting print portions 5Bb, each serving as a reflective light emitting portion, but on the non-light-emitting print portions 5Ba, each serving as a light guide portion. There is almost no possibility that the projecting portions 30 hinder the light-emitting print portions 5Bb from emitting light.

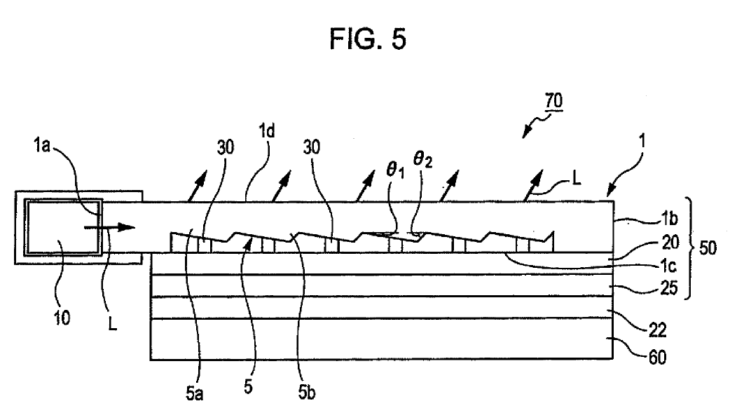

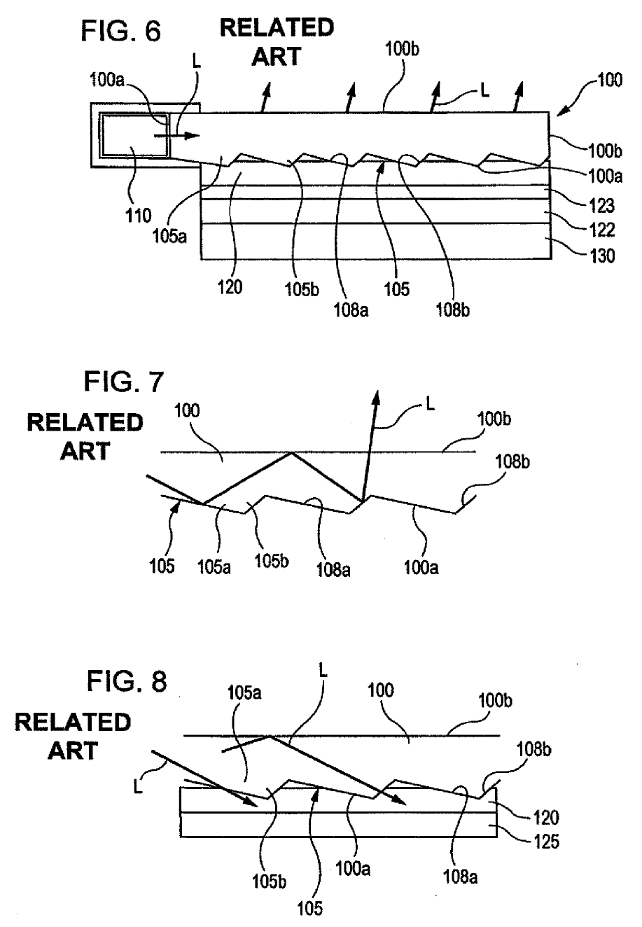

FIG. 5 shows a light emitting sensor device 70 formed by combining the surface light emitting device 50 shown in FIG. 1 and an electrostatic sensor (glide point) 60 that operates upon detecting an electrical change of a surface. In this light emitting sensor device 70, a reflection plate 25 of the surface light emitting device 50 is securely adhered to the electrostatic sensor 60 via a second adhesion sheet 22. The light emitting sensor device 70 is electrically controlled so that the surface light emitting device 50 emits light in a predetermined form, accompanied with an operation of the electrostatic sensor 60 that detects an extraneous stress.

In the light emitting sensor device 70, it is necessary to strongly adhere the light guide plate 1 to the sensor 60 in order to correctly convey a stress applied through the light guide plate 1 or an electrical change of a surface to the sensor 60, as well as to prevent the light guide plate 100 itself from being moved by the extraneous stress. Simultaneously, it is necessary to prevent the optical characteristic of the light guide plate 1 from being impaired by the adhesive fixation. In this relation, as described above, the light guide plate 1 in the surface light emitting device 50 is strongly adhered to the light reflector 25, for example, to the electrostatic sensor 60. The existence of the projecting portion 30 prevents contact between the prisms 5 and first adhesion sheet 20. There is almost no possibility that the prisms 5 will be buried under the second adhesion sheet 20. These can reliably satisfy the above-described conditions.

The numeric values or materials described in the above-described embodiments are not particularly restricted. Also, the constructions in the above-described embodiments are not limited, but modifications and variations thereof may be made as appropriate without departing from the sprit and scope of the present invention.

What is claimed is:

1. A light guide member comprising:
an end face that receives light from a light source;
a pair of main surfaces opposed to each other;
an optical path changing device disposed on one of the main surfaces;
a light guide portion that propagates the light from the light source to the inside of the light guide member;
a reflective light emitting portions that reflect the light from the light source toward the other of the main surfaces; and
a projection portion that extends by a predetermined length from the light guide portion toward the outside of the light guide member.

2. The light guide member according to claim 1, wherein, the optical path changing device is disposed where the predetermined region is luminous on the one of the main surfaces of the light guide member.

3. The light guide member according to claim 1, wherein the optical path changing device comprises prisms with a substantially scalene triangular cross-section, the prisms comprising a light guide portion tilted at a predetermined first angle with respect to the one of the main surfaces, and the reflective light emitting portion tilted at a second angle larger than the first angle with respect to the one of the main surfaces.

4. The light guide member according to claim 1, wherein the front end of each of the projecting portions has a substantially hemispheric shape.

5. The light guide member according to claim 1, wherein the projection portions are aligned with each other at substantially uniform spacings.

6. A surface light emitting device comprising:
a light source;
a light guide member comprising a pair of main surfaces opposed to each other, an optical path changing device disposed on one of the main surfaces, and a projection portion; and
a light reflector or a light absorber opposed to the one of the main surfaces, the one of the main surface having thereon the optical path changing device.

7. A light emitting sensor device comprising:
a sensor that is operable to detect an extraneous stress or an electrical change of a surface; and
a surface light emitting device fixed on the sensor, wherein the surface light emitting device comprises: a light source; a light guide member comprising a pair of main surfaces opposed to each other, an optical path changing device disposed on one of the main surfaces, and a projection portion; and a light reflector or a light absorber opposed to the one of the main surfaces, the one of the main surface having thereon the optical path changing device.

8. A light guide member comprising: an end face that receives light from a light source; a pair of main surfaces opposed to each other fixed on a mounting surface;
an optical path changing device disposed on one of the main surfaces, and that has a light guide portion that propagates the light from the light source to the inside of the light guide member, and reflective light emitting portion that reflects the light from the light source toward the other of the main surfaces; and
a projecting portion disposed on the light guide portion in a projecting manner and interposed between the mounting surface and the light guide portion.

9. The light guide member according to claim 8, wherein, the optical path changing device is disposed in a luminous region on the one of the main surfaces of the light guide member.

10. The light guide member according to claim 8, wherein the optical path changing device comprises prisms having a substantially scalene triangular cross-section, the prisms comprising a light guide portion tilted at a predetermined first angle with respect to the one of the main surfaces, and reflective light emitting portions tilted at a second angle larger than the first angle with respect to the one of the main surfaces.

11. The light guide member according to claim 8, wherein the front end of each of the projecting portions has a substantially hemispheric shape.

12. The light guide member according to claim 8, wherein the projection portions are aligned with each other at substantially uniform spacings.

13. The light guide member according to claim 8, wherein an adhesive layer is formed on the mounting surface, and the projecting portions are securely adhered on the adhesive layer so as to prevent the optical path changing device from making contact with the adhesive layer.

14. The light guide member according to claim 8, wherein the light guide member comprises a material having a refractive index higher than the refractive index of a material used for the adhesive layer is used.

15. A light emitting sensor device comprising:
a sensor that operates upon detecting an extraneous stress or an electrical change of a surface; and
a surface light emitting device being fixed on the sensor, wherein the surface light emitting device comprises: a light source;
an optical path changing device having a light guide portion that propagates the light from the light source to the inside of the light guide member, and reflective light emitting portion that reflects the light from the light source toward the other of the main surfaces; and
a projecting portion disposed on the light guide portion in a projecting manner and interposed between the mounting surface and the light guide portion;
a light guide member comprising a pair of main surfaces opposed to each other, an optical path changing device disposed on one of the main surfaces, and a projection portion; and
a light reflector or a light absorber opposed to the one of the main surfaces, the one of the main surface having thereon the optical path changing device.

16. The surface light emitting device according to claim 6, wherein the light guide member further comprises: a light guide portion that propagates the light from the light source to the inside of the light guide member, and reflective light emitting portions that reflect the light from the light source toward the other of the main surfaces; and
wherein the projection portion extends by a predetermined length from the light guide portion toward the outside of the light guide member.

17. The surface light emitting device according to claim 6, wherein the light guide member comprises:
an optical path changing device having a light guide portion that propagates the light from the light source to the inside of the light guide member, and reflective light emitting portion that reflects the light from the light source toward the other of the main surfaces; and
a projecting portion disposed on the light guide portion in a projecting manner and interposed between the mounting surface and the light guide portion.
